(19) United States
(12) Patent Application Publication
(10) Pub. No.: US 2002/0071972 A1
(43) Pub. Date: Jun. 13, 2002

(54) Fuel cell battery with heating and an improved cold-start performance, and method for cold-starting of a fuel cell battery

(76) Inventors: Ulrich Gebhardt, Langensendelbach (DE); Gunter Luft, Lauf (DE); Konrad Mund, Uttenreuth (DE); Manfred Waidhas, Nurnberg (DE); Rittmar Von Helmolt, Mainz (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/950,427

(22) Filed: Sep. 10, 2001

Related U.S. Application Data
(63) Continuation of application No. PCT/DE00/00740, filed on Mar. 9, 2000.

(30) Foreign Application Priority Data
Mar. 9, 1999 (DE) 199 10 387.9

(51) Int. Cl. H01M 8/04; H01M 8/12

(52) U.S. Cl. 429/13; 429/20; 429/26; 429/32

(57) ABSTRACT

A fuel cell battery is described with a heater and an improved cold-start performance, and to a method for cold-starting of a battery of this type. The heater, such as for example a reformer, is started first, and the operating heat from the heater is utilized to heat the fuel cell stack.

### CROSS-REFERENCE TO RELATED APPLICATION

This application is a continuation of copending International Application No. PCT/DE00/00740, filed Mar. 09, 2000, which designated the United States.

### BACKGROUND OF THE INVENTION

1. Field of the Invention

The invention relates to a method for the cold-starting of a fuel cell battery containing proton-conducting electrolyte membrane (PEM) fuel cells which, in stacked form, form a fuel cell stack. The invention also relates to the associated fuel cell battery for carrying out the method. The cold-starting properties are in this context referred to as what is known as the cold-starting performance.

A fuel cell battery has an electrolyte for each fuel cell unit, such as for example an ion exchange membrane in the case of a PEM fuel cell, the membrane containing a sulfanated chemical compound as its principal constituent. This group of chemical compounds binds water in the membrane, in order to ensure sufficient proton conductivity. At a temperature of below 0° C., the freezing of the water stored in the membrane causes the membrane resistance to rise suddenly by 2-3 powers of 10, making a cold start more difficult.

To avoid the latter problem, at a low ambient temperature it is either possible for the battery, even when not in use, to be operated with a minimal load, so that the temperature does not drop below the freezing point, or to have a thermocouple fitted, so that as soon as the temperature falls sufficiently far for there to be a threat of the electrolyte resistance rising suddenly, the battery starts up and is heated through operation.

What is referred to as short-circuit operation can also be used, in which the battery is continuously short-circuited in the heating-up phase, so that all the fuel cell power is used as short-circuit heat for heating up the electrolyte when operation starts.

However, short-circuit operation has the disadvantage that an extremely high electrolyte resistance must be overcome at temperatures below the freezing point of water, before the cell starts to run and in consequence be heated up.

Methods for cold-starting of a fuel cell battery in which the consumption of reaction gas is drastically increased during starting or which require very long starting times are substantially known. Specifically, it is known from the prior art to provide auxiliary devices for start-up operation for fuel cell configurations with different types of fuel cells. In particular, it is disclosed by U.S. Pat. No. 5,019,463 that a reformer, in which the exhaust gas which is formed during the reforming process of a primary fuel is selectively preheated and introduced into the fuel cell stack via a dedicated line, is connected upstream of the fuel cell arrangement. Furthermore, it is known from Japanese Patent Application JP 01-071074 A and Japanese Patent JP 01-124962, to introduce reformer gas into the fuel cell stack or, alternatively, to use hydrogen and oxygen in the stack to heat the fuel cells directly by a catalytic burner. For this purpose, different variants for specific types of fuel cells are disclosed in Japanese Patent Applications JP 02-139871 A, JP 59-098471 A, JP 05-089899 A, JP 61-088460 A, JP 04-269460 A, JP 01-071075 A and JP 61-158672 A.

### SUMMARY OF THE INVENTION

It is accordingly an object of the invention to provide a fuel cell battery with heating and an improved cold-start performance, and a method for cold-starting of a fuel cell battery that overcomes the above-mentioned disadvantages of the prior art methods and devices of this general type, which allows operation even at low temperatures without a drastically increased consumption of process gas. For this purpose, it is intended to provide a fuel cell battery with an improved cold-starting performance. The primary considerations are, above all, an increase in the efficiency of the overall installation, a reduction in the heat loss from the overall system and a simple construction of the installation.

With the foregoing and other objects in view there is provided, in accordance with the invention, a method for cold-starting a fuel cell battery containing proton-conducting electrolyte membrane (PEM) fuel cells which, in stacked form, form a fuel cell stack. The method includes the steps of utilizing waste heat from a combustion of a primary fuel and/or a secondary fuel directly, in a form of an exhaust gas, to heat the fuel cell stack; and introducing the waste heat in a controlled manner into the PEM fuel cells of the fuel cell stack. As a result of the waste heat, water which has frozen at temperatures of below 0° C. in an electrolyte of the PEM fuel cells is converted into a liquid state, and is heated to a temperature of below 100° C., with the result that the water remains bound in the membrane.

With the foregoing and other objects in view there is provided, in accordance with the invention, a fuel cell battery. The fuel cell battery contains a fuel cell stack containing proton-conducting electrolyte membrane (PEM) fuel cells having reaction chambers, a heater, and at least one line connected between the heater and the fuel cell stack. Through the line, heat can be dissipated in a controlled manner into the fuel cell stack without an interconnected heat exchanger, so that a heating of the reaction chambers of the PEM fuel cells in the fuel cell stack can be set to a temperature of below 100° C.

The invention has the advantageous effect, for the fuel cell battery which contains PEM fuel cells with a sulfonated membrane, that the reaction chamber is not heated to a temperature of over 100° C., and consequently the water remains bound in the membrane.

In accordance with an added feature of the invention, the heater is a reformer or a part of a reformer system.

In accordance with an additional feature of the invention, a circulation system is provided and contains a heat-transfer medium and the line is part of the circulation system. The circulation system runs both through the heater and through the fuel cell stack, so that the heat-transfer medium contained therein, during a cold start, is heated in the heater and is cooled in the fuel cell stack.

In accordance with a further feature of the invention, at least one process-gas duct is provided and the line is also part the process-gas duct, so that the heat-transfer medium which has been heated can be introduced into the process-gas duct through the line.

In accordance with another feature of the invention, the line is one of a plurality of lines connected between the heater and the fuel cell stack.

In accordance with a concomitant feature of the invention, the heater contains a catalytic burner.

Other features which are considered as characteristic for the invention are set forth in the appended claims.

Although the invention is described herein as embodied in a fuel cell battery with heating and an improved cold-start performance, and a method for cold-starting of a fuel cell battery, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

In the method according to the invention, exhaust gases from an upstream heater are introduced directly into a fuel cell stack, so that, therefore, unburnt feed gas, for example, is passed through the fuel cell stack as part of the reformer exhaust gas.

In an associated fuel cell battery, there is a heater, in which at least one line is provided from the heater to the fuel cell stack, so that the heat can be dissipated into the fuel cell stack. The invention also relates to a method for cold-starting, in which the waste heat from the combustion of the primary and/or secondary fuel is utilized to heat the fuel cell stack.

The term heater refers to any heatable area in which, also including the use of a heat exchanger, a heat-transfer medium can be heated. The heater preferably contains a heater element, such as a catalytic burner and/or an electrical heater element. A running reformer may therefore also be a heater within the context of the invention.

The line from the heater to the fuel cell stack may be part of a circulation system, in which a heat-transfer medium is heated in the reformer and/or in the heating and is then passed to the fuel cell stack, where it releases the heat. This line may be interrupted while the fuel cell stack is operating. The heat transfer medium may, in a manner which is known per se, be the exhaust gas from the reformer, i.e. reforming gas, the exhaust gas from the catalytic burner, a heated gas, such as for example CO₂, secondary fuel, etc., natural gas, a methanol/water mixture, a liquid with a high specific heat capacity, such as oil, silicone oil, methanol, some other alcohol, pure water or the like, it being a condition that the heat-transfer medium should not be electrically conductive. In one configuration, the line represents a gas connection between the reformer chamber and the reaction chambers of the fuel cell stack, so that a hot heat-transfer medium is passed through the reaction chambers of the fuel cell stack and, in the process, heats them. This is possible, for example, by introducing the heated heat-transfer medium into the process-gas duct with or without “dilution” by process gas. In the process, the heated heat-transfer medium flows along the paths along which, in operation, the process gas flows, through the fuel cell stack. It is also possible for the hot exhaust gas from the reforming reaction simply to be passed into one or both process-gas ducts and/or automatically into the stack and through the reaction chambers of the latter. In this case, to save fuel, the reaction conditions in the reformer are preferably selected in such a way that, unlike for the H₂ production, substantially heat is produced. The supply of oxygen or air to the reformer should therefore be temporarily increased during the cold start, so that complete combustion takes place instead of partial oxidation.

In a further configuration, it is possible to provide a plurality of lines between the heater and the stack. In this case, the heater may be disposed in the immediate vicinity of the stack, so that in extreme circumstances the lines are heat lines that consist of the contact areas between the heater and the fuel cell unit(s) of the stack. It is possible, for example, for the reformer to be placed directly adjacent to the stack, and in extreme circumstances the outer walls of the two units may even directly abut one another. In this configuration, the lines are all connections which are firmly conductive, i.e. all direct wires, tubes and/or ducts which mechanically adjoin the heater and the stack, and all other connections which are able to transfer heat.

In one configuration of the invention, the reformer is heated by a catalytic burner that is, for example, integrated in the reformer and/or is disposed centrally in the middle of the reformer, for example.

A PEM fuel cell battery contains at least one stack having at least one fuel cell unit containing the PEM fuel cells. There are corresponding process-gas supply and discharge ducts (known as the process-gas ducts), a cooling system and associated end plates. The reformer and/or the heater may be integrated in the fuel cell installation or may be externally operated.

The term reaction gas refers to the gas of the reactant, i.e. for example MeOH, H₂ and/or O₂, whereas the term process gas refers to the gas/liquid mixture that is introduced into the reaction chambers. The process gas contains a plurality of components, such as for example steam, inert gas, etc., in addition to the reaction gas and may also include primary fuel.

The term primary fuel is understood as meaning gasoline, methanol, methane, etc., i.e. fuels from which a secondary fuel, such as a hydrogen-containing gas mixture or hydrogen, is produced in a reformer.

According to one configuration of the invention, a catalytic burner is provided in the reformer in which the primary fuel is burnt, so that a controlled combustion with low emissions of pollutant is achieved. The catalytic burner ensures uniform conversion. The heat from the combustion is then passed to the fuel cell stack, for example via heat exchangers or by the passage of the exhaust gases through the fuel cell stack.

The invention has made it possible, for the first time, for a fuel cell battery to be cold-started without a drastically increased consumption of reaction gas, since the heat of combustion of the primary and/or secondary fuel is utilized directly and/or indirectly to heat the cold stack.

We claim:

1. A method for cold-starting a fuel cell battery containing proton-conducting electrolyte membrane (PEM) fuel cells which, in stacked form, form a fuel cell stack, which comprises the steps of:
utilizing waste heat from a combustion of at least one of a primary fuel and a secondary fuel directly, in a form of an exhaust gas, to heat the fuel cell stack; and
introducing the waste heat in a controlled manner into the PEM fuel cells of the fuel cell stack, as a result of the waste heat, water which has frozen at temperatures of below 0° C. in an electrolyte of the PEM fuel cells is converted into a liquid state, and is heated to a temperature of below 100° C., with the result that the water remains bound in the membrane.

2. A fuel cell battery, comprising:
a fuel cell stack containing proton-conducting electrolyte membrane (PEM) fuel cells having reaction chambers;
a heater;
at least one line connected between said heater and said fuel cell stack, and through said line, heat can be dissipated in a controlled manner into said fuel cell stack without an interconnected heat exchanger, so that a heating of said reaction chambers of said PEM fuel cells in said fuel cell stack can be set to a temperature of below 100° C.

3. The fuel cell battery according to claim 1, wherein said heater is one of a reformer and a part of a reformer system.

4. The fuel cell battery according to claim 2, including a circulation system containing a heat-transfer medium and said line is part of said circulation system, said circulation system running both through said heater and through said fuel cell stack, so that the heat-transfer medium contained therein, during a cold start, is heated in the heater and is cooled in said fuel cell stack.

5. The fuel cell battery according to claim 4, including at least one process-gas duct and said line is also part said process-gas duct, so that the heat-transfer medium which has been heated can be introduced into said process-gas duct through said line.

6. The fuel cell battery according to claim 1, wherein said line is one of a plurality of lines connected between said heater and said fuel cell stack.

7. The fuel cell battery according to claim 2, wherein said heater contains a catalytic burner.
